(19) United States
(12) Patent Application Publication
(10) Pub. No.: US 2019/0080056 A1
(43) Pub. Date: Mar. 14, 2019

(54) SYSTEMS AND METHODS FOR REMOTE PATIENT MONITORING AND EVENT DETECTION

(71) Applicant: QUALCOMM Incorporated, San Diego, CA (US)

(72) Inventors: Soumya DAS, San Diego, CA (US); Edwin Chongwoo PARK, San Diego, CA (US); Olufunmilola Omolade AWONIYI-OTERI, San Diego, CA (US); Ashutosh AGGARWAL, San Diego, CA (US)

(21) Appl. No.: 15/704,646

(22) Filed: Sep. 14, 2017

(51) Int. Cl. G06F 19/00; G06N 99/00

(52) U.S. Cl. CPC G06F 19/3418; G06N 99/005; G06F 19/345

(57) ABSTRACT

Methods, systems, computer-readable media, and apparatuses for remote patient monitoring and event detection are presented. For example, one method includes receiving, by a computing device via wireless communication, one or more sensor signals from a sensor associated with a patient; obtaining a patient condition based on the one or more sensor signals using a trained machine-learning (“ML”) model; and responsive to detecting an emergency condition based on the patient condition, providing an indication of the emergency condition.

### BACKGROUND

While a patient is in a hospital and under observation, medical professionals (e.g., doctors and nurses) may monitor the patient using a variety of sensors. These sensors can very quickly provide notifications when a potential issue arises and the response time can be very fast—an on-call nurse may arrive within the patient's room within seconds of an alarm condition occurring. However, after a patient has been released from the hospital and sent home or to a non-hospital setting, it may be difficult to continuously monitor the patient's health conditions and provide quick responses in the event of an emergency condition occurring. This problem may be exacerbated in cases where a health care provider is remotely monitoring a high number of chronically ill patients or patients going through transitional care, such as following a surgery. Studies have shown that response times to emergencies can increase substantially in these high-load situations leading to life-threatening conditions.

### BRIEF SUMMARY

Various examples are described for systems and methods for remote patient monitoring and event detection. One example method includes obtaining, by a computing device via wireless communication, one or more sensor signals from a sensor associated with a patient; determining a patient condition based on the one or more sensor signals using a trained machine-learning (“ML”) model; and responsive to detecting an emergency condition based on the patient condition, providing an indication of the emergency condition.

One example device includes a wireless transceiver; a non-transitory computer-readable medium; and a processor in communication with the wireless transceiver and the non-transitory computer-readable medium, the processor configured to obtain, using the wireless transceiver, one or more sensor signals from a sensor associated with a patient; determine a patient condition based on the one or more sensor signals based on a trained machine learning (“ML”) model; detect an emergency condition based on the patient condition; and provide an indication of the emergency condition.

One example non-transitory computer-readable medium includes processor-executable instructions configured to cause a processor of a computing device to obtain, via wireless communication, one or more sensor signals from a sensor associated with a patient; determine a patient condition based on the one or more sensor signals based on a trained machine-learning (“ML”) model; detect an emergency condition based on the patient condition; and provide an indication of the emergency condition.

One example apparatus includes means for obtaining one or more sensor signals from a sensor associated with a patient; means for determining a patient condition based on the one or more sensor signals based on a trained machine-learning (“ML”) model; means for detecting an emergency condition based on the patient condition; and means for providing an indication of the emergency condition.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1 and 2 show example systems for remote patient monitoring and event detection;

FIG. 3 shows an example computing device for remote patient monitoring and event detection; and

FIG. 4 shows an example method for remote patient monitoring and event detection.

### DETAILED DESCRIPTION

Examples are described herein in the context of systems and methods for remote patient monitoring and event detection. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

To help address the issue of extended response times in remote patient monitoring scenarios, including in scenarios where a health care provider may have a significant patient load, an illustrative example of a patient remote monitoring system may include one or more sensors that are carried or worn by the patient, such as heart rate monitors, pulse monitors, accelerometers, etc. These sensors may be connected to a patient device which acts as health gateway, such as a virtual assistant device, a smartphone, tablet, personal computer, etc. The health gateway is in communication with a health care provider backend, directly or indirectly, via a communications network.

The health gateway receives signals from the patient's sensors and employs a machine learning (“ML”) engine to execute one or more trained ML models to monitor the patient's condition. The monitoring may be performed regarding the patient's general health, such as by monitoring heart rate, blood pressure, etc., or with respect to specific conditions, such as chronic conditions or a temporary condition following discharge from a hospital or other patient care center. The ML engine processes the received sensor information using its trained model(s) and determines one or more patient conditions. The output of the ML engine could be any appropriate generic condition, such as “normal,” “elevated” or “at risk,” “warning,” “critical,” “emergency,” etc., or it may include more specific information, such as “elevated heart rate,” “low blood pressure,” low blood sugar,” etc., based on the respective ML model. [ECP: do we need to explicitly cover the case where part of the ML inference is done at the gateway and the rest elsewhere. In many ways, the term “elevated” covers this. It could be elevated and running additional models at the service platform can determine that the person is “at risk”, etc.]

To enable the health gateway to perform these functions, the health gateway is provided with a trained ML model. The training may be performed by the health care provider using labelled training data, such as by using various data available within its data repository. Or the training of the model may be performed by another third party, such as a service platform, or even by the heath gateway itself. The patient remote monitoring system may also adjust where training occurs based on performance characteristics of the patient device. For example, for a low power device or a device with limited resources, the patient remote monitoring system may provide the device with a trained ML model. However, for a state-of-the-art smartphone or tablet, the patient device may be provided with a set of training data and may itself train the ML model.

In addition to providing the sensor information to the ML model, the patient device may also provide the sensor information to the health care provider system (or other remote system, such as a cloud-based service platform). Such information may be logged as specific patient data, used to further refine one or more ML models, communicated to the patient's doctor or surgeon, etc. Depending on the importance of the information, the health gateway may also tag the information as being of higher importance, which may prioritize its transmission or processing within the service or health care provider systems.

After classifying the monitored patient's condition, the health gateway may provide an indication of the monitored patient's condition to the health care provider for action, such as notifying a doctor or contacting emergency services (e.g., 911), or it may provide a notification to the patient, such as by providing a notice on the smartphone's screen, or to the patient's emergency contacts, such as their immediate family members. In some cases, such as in an emergency, the health gateway may notify the service provider or health care provider, but also directly contact emergency services.

By providing the health gateway with a trained ML model that can recognize different patient conditions, the health care provider can offload processing of patient information and provide improved response times when emergency conditions are detected. In addition, the use of the health gateway may reduce errors that might otherwise occur when a medical professional is handling a large volume of data for multiple remotely-monitored patients.

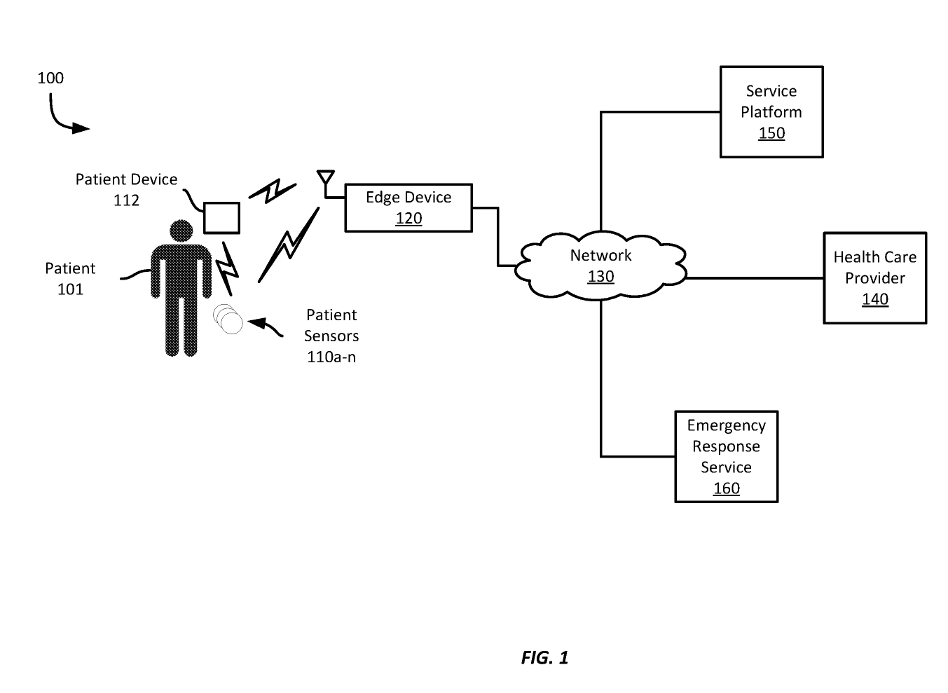

Referring now to FIG. 1, FIG. 1 shows an example system 100 for remote patient monitoring and event detection. The system 100 enables monitoring of the patient's condition while the patient is away from a health care facility, such as a hospital or physician's office. The system 100 can obtain sensor information about the patient and determine the patient's condition, which may include detecting emergency events or monitoring a patient's status with respect to a health condition, including temporary conditions (e.g., recovery after surgery) or chronic conditions (e.g., high blood pressure, arrhythmia, etc.). If needed, the system 100 can provide information to the patient's health care provider or to emergency services to provide assistance to the patient. By offloading detection of patient condition to the remote patient monitoring system 100 from one or more health care personnel, the system 100 can help ensure that conditions warranting a medical response are identified, and not missed by overloaded health care personnel. Thus, the health care personnel can focus their attention on those patients that need assistance, while allowing the system to otherwise autonomously monitor those patients whose conditions are normal.

The system 100 includes one or more patient sensors 110a-n, a patient device 112, and a health gateway, more generally referred to as an edge device 120. It should be appreciated that the use of “n” in label “110n” represents any arbitrary number of sensors, i.e., “n” sensors. The patient sensors 110a-n are in communication with the edge device 120, such as via one or more wired or wireless communication techniques, including Ethernet, serial or parallel communication techniques (e.g., RS-232, RS-485, IEEE 1284, etc.), analog voltage or current communication lines, BlueTooth (“BT”), WiFi, BT Low Energy (“BLE”), near-field communications (“NFC”), etc. The edge device 120, in turn, is in communication with a health care provider system 140, a service platform system 150, and an emergency response service (ERS) system 160 via the network 130, which may be any suitable network or combination of networks, including a local area network (“LAN”); wide area network (“WAN”), such as the Internet; metropolitan area network (“MAN”); point-to-point or peer-to-peer connection; etc. Communication between the edge device 120 and the systems 140-160 may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While in this example, the edge device 120 is able to directly communicate with each of these systems 140-160, in some examples, the edge device 120 may communicate indirectly with one or more of these systems 140-160. For example, the edge device 120 may directly communicate with a server at the service platform system 150, which may then relay information to the health care provider system 140. Similarly, one or more of the service platform system 150 or health care provider system 140 may relay emergency conditions to the ERS system 160, rather than the edge device 120 directly communicating with the ERS system 160.

The patient sensors 110a-n include any suitable physiological, inertial, location, etc. sensor and may be included in one or more patient devices, included in the edge device 120 itself, worn by the patient, be located in the patient's home or vehicle, implanted within the patient, or otherwise be positioned to sense information about the patient's condition. Suitable physiological sensors include sensors configured to sense physiological states of the patient, including pulse rate, pulse wave velocity, blood pressure, glucose levels, blood oxygen levels, temperature, breathing rate, wakeful or sleeping states, etc. Inertial sensors include sensors configured to sense the patient's movements, such as walking, running, tremors or shaking, etc., including accelerometers, gyroscopes, rotational or linear encoders, etc. Other types of sensors include position sensors, such as Global Navigation Satellite System (“GNSS”) receivers, such as Global Positioning System (“GPS”) receivers. Position sensors may include BT, BLE, WiFi, cellular, etc. transceivers that can determine position based on received wireless signals or from a wireless access point or base station. In some examples, a sensor may obtain or request explicit patient input, such as by requesting a patient perform a blood pressure test, finger prick test (e.g., for blood glucose), or provide responses to one or more questions (e.g., how are you feeling?). Still further types of sensors may be employed according to different examples.

The patient sensors 110a-n may be incorporated into one or more patient devices, such as the edge device 120; any portable patient device, such as a smartphone, laptop computer, glucose pump, etc.; any wearable patient device, such as a smartwatch, armband, headband, earbud or earphone(s), etc.; or a standalone patient device, such as a desktop computer, a tabletop heart rate monitor, etc. Multiple sensors may be contained in the same device, may be separately incorporated into discrete devices, or the sensors themselves may be applied to the patient, or otherwise positioned to sense information about the patient's condition and communicate sensor information to the edge device 120.

The edge device 120 may be any suitable computing device configured to receive sensor information from one or more of the sensors 110a-n, directly or indirectly. In some examples, the edge device 120 may be a portable device, such as a smartphone, tablet computer, laptop computer, etc. But in other examples, the edge device 120 may be a relatively stationary device, like a virtual assistant hub (e.g., an Amazon® Echo® or Google® Home® device), a desktop computer, an Internet-of-Things (“IOT”) hub, etc.

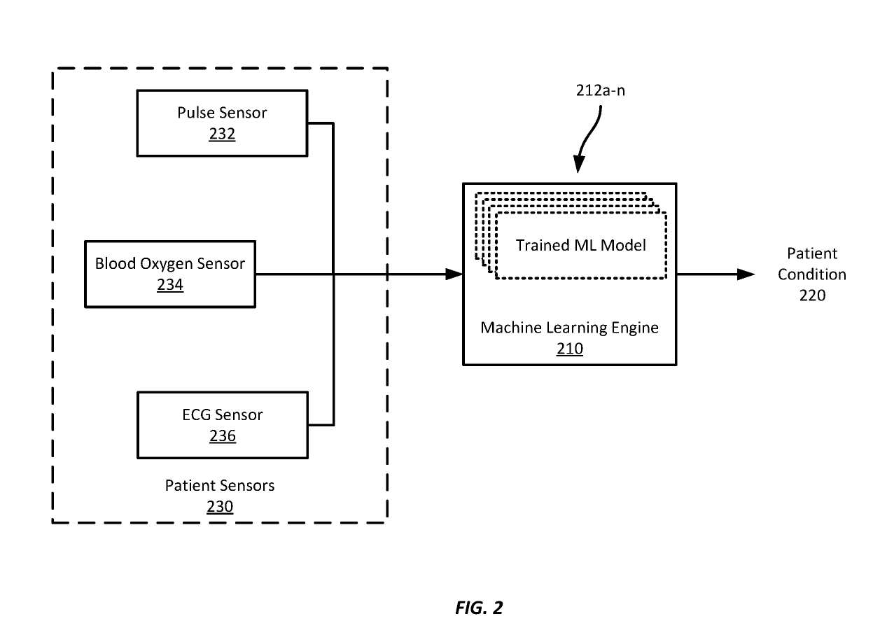

In this example, the edge device 120 is configured to receive sensor information and to execute a trained ML model to determine a patient condition based on the received sensor information, as will be discussed in more detail with respect to FIG. 2 below. The patient condition may be any condition the ML model has been trained to detect. Patient conditions may include temporary conditions, such as related to recovery from surgery or other medical procedure, treatment of an injury or disease, etc., or may include chronic or permanent conditions, such as high blood pressure, tachycardia, atrial fibrillation, diabetes, etc. In some examples, a patient condition may be an indication of a normal or abnormal patient state. For example, a patient may have high blood pressure for which they are taking medication. Thus, the ML engine may output a “normal” patient condition if the patient's blood pressure sensor indicates a blood pressure within the patient's expected range, while an “elevated blood pressure” patient condition may be indicated if the blood pressure is above the expected range by a reference threshold. A further patient condition may be “emergency blood pressure” may be indicated if the patient's blood pressure is above the expected range by an additional reference threshold. Similarly, other patient conditions related to temporary, chronic, or permanent health conditions may be determined based on information from individual sensors or information obtained from multiple different kinds of sensors.

The health care provider system 140 has one or more computer servers operated by a health care provider, such as a hospital, clinic, physician's office, etc. that accepts information from the edge device 120 and determines a response, if any, based on the received patient condition information. Thus, the health care provider system 140 may be configured to ingest information about a particular patient's condition, update one or more electronic health records (“EHRs”) for the patient and trigger a needed response. Such responses may range from taking no action, to a phone call to the patient from the health care provider and ultimately to dispatching an emergency response team, such as an ambulance or helicopter, or contacting an ERS system 160.

The service provider system 150 represents a third party provider of services to the patient via the edge device 120. The service provider system 150 may provide response services to the patient based on received patient condition information from the edge device 120 before the patient's health care provider is contacted. Thus the service provider system 150 may provide services to the patient for conditions that do not require intervention by the health care provider. In some examples, the service provider system 150 may also store information received from the edge device 120, which may include sensor information, determined patient conditions, or both. The service provider system 150 may also have one or more trained ML models to determine a patient condition based on received sensor information. In some examples, if the edge device 120 lacks a trained ML model, the service provider system 150 may instead determine a patient condition.

In this example, the ERS system 160 is a 911 system that provides emergency services to any member of the public, and may dispatch fire, police, or medical emergency responders. However, in some examples, the ERS system 160 may a proprietary ERS system operated by a company or health care provider, such as an emergency room or ambulance service. The ERS system 160 can receive patient condition information from one or more of the edge device 120, the health care provider system 140, or the service platform system 150. Based on the received patient condition information, the ERS system 160 may dispatch an ambulance, a helicopter, or other response vehicle or team to the patient's location.

Thus, the system 100 for remote patient monitoring and event detection shown in FIG. 1 provides monitoring of a patient's condition by sensing physiological or other information about the patient, determining a patient's condition using a trained ML model, and if an actionable patient condition is detected, transmitting a notification to one or more of the health care provider system 140, the service platform system 150, or the ERS system 160. Such notifications may enable a health care provider to remotely monitor a patient, even in conditions where the health care provider is monitoring a large number of patients and is receiving a significant amount of patient condition information.

Referring now to FIG. 2, FIG. 2 shows an example system 200 for remote patient monitoring and event detection. The example system 200 includes a ML engine 210, which incorporates one or more trained ML models, that receives sensor information from one or more patient sensors 230. In this example, the patient sensors 230 include a pulse sensor 232, a blood oxygen sensor 234, and an electrocardiogram (“ECG”) sensor 236. The ML engine 210 in this example is executed by an edge device, such as the edge device 120 shown in FIG. 1. The patient sensors 230 may also be included within the edge device, but may be incorporated into other devices as discussed above with respect to FIG. 1.

Sensor information is communicated from the sensors 232-236 to the ML engine 210 using a wired or wireless communications technique, as discussed above with respect to FIG. 1. The ML engine 210 receives the sensor information and executes one or more trained ML models 212a-n to determine one or more patient conditions 220. As discussed above, patient conditions 220 may indicate medical conditions, activities, or one or more thresholds that have been reached or exceeded. For example, the ML engine 210 may be able to use one or more trained ML models 212a-n to determine medical conditions, such as heart attacks, strokes, etc.; activities, such as sleeping, sitting, walking, etc.; or threshold events, such as high or low blood pressure events, tachycardia, high or low blood sugar events, low blood oxygen levels, etc.

In some examples, the ML engine 210 may determine qualitative patient conditions, such as “normal,” “warning,” “emergency,” “critical,” “life-threatening,” etc. Such qualitative patient conditions may be the only determined patient condition 220 or may be an annotation associated with a determined medical condition. For example, if the ML engine 210 determines a “low blood pressure” event, the ML engine 210 may determine whether the event is a “warning” event, where the patient's blood pressure is slightly below a “normal” range, or whether it is an emergency event, where the patient's blood pressure is significantly below the “normal” range. Such a qualitative patient condition may be used to determine whether to provide a notification to one or more of the systems 140-160 shown in FIG. 1, whether to prioritize transmission of the patient condition to one of the systems 140-160, which of the systems 140-160 to notify, or whether to transmit a request for emergency services, such as from an ERS system.

As discussed above, the ML engine 210 can receive sensor information from one or more patient sensors 232-236 and execute one or more trained ML models 212a-n to determine a patient condition 220. The ML engine 210 in this example uses ML models 212a-n that have been trained using labelled sensor data sets generated from actual or simulated sensor information, such as pulse rate information, ECG information, blood oxygen information, blood glucose information, etc. Suitable training techniques thus may include supervised training techniques or continuous optimization techniques. During training in this example, outputted patient conditions by the ML engine 210 may be compared against the desired output and any errors in the output may be fed back into the ML engine 210 to modify the ML model executed by the ML engine 210. In some examples, the ML engine 210 may execute multiple different ML models concurrently based on received sensor information. Different ML models 212a-n may include models specific to a particular treatment or patient condition, for more generalized health monitoring, or specific to a particular patient.

Further, different ML models 212a-n may be trained based on a patient's particular temporary or chronic health conditions. For example, the ML engine 210 may be provided with a trained ML model that has been trained based on patient sensor information from a variety of different patients to create a generally-applicable trained ML model for particular temporary or chronic condition. However, one or more trained models may be trained using sensor data gathered from patient sensors monitoring a particular patient. Thus, the patient's “normal” condition may be determined specifically for the patient. For example, such patient-specific models may be employed by an ML engine 210 instead of, or along with, ML models that have been trained using sensor information from a larger patient population.

In some examples, training of the ML models 212a-n may be performed by the edge device 120 using received sensor information and corresponding determined patient conditions; however, in some examples, the edge device 120 may determine a patient condition and may also provide received sensor signals from one or more patient sensors 110a-n, one or more determined patient conditions, or both to a remote computing device, such as a device at the service platform system 150 or the health care provider system 140, which may then train one or more ML models. The remote computing device may then provide one or more trained ML models to the edge device 120 (or other computing device, such as a patient device), which may then be used by the ML engine 210. In some examples, the edge device 120 may not execute an ML engine 210, or may only execute the ML engine 210 for certain sensor information or for a particular trained ML model (or models) 212a-n. Thus, in some example the edge device 120 may provide sensor information to a remote computing device to determine a patient condition, as discussed above, instead of, or in addition to, patient conditions determined by the edge device 120.

Once the ML models 212a-n have been trained, the ML engine 210 receives sensor information from one or more of the sensors 232-236 and determines one or more patient conditions. It should be appreciated that in some examples multiple patient conditions may be detected from a set of sensor information. Further, any suitable ML technique may be employed according to different examples.

The various patient sensors 232-236 shown in FIG. 2 transmit sensor information to the ML engine 210, though one or more of the signals may be filtered or otherwise processed prior to being provided to the ML engine 210. For example, the pulse sensor 232 may detect an individual's pulse using any suitable pulse sensor, such as using infrared light emitters and detectors. The pulse sensor 232 may then provide to the ML engine 210 any related information according to different examples, such as pulse rate, individual pulses (with or without time stamps), pulse characteristics, pulse wave velocity, etc. Alternatively, the pulse sensor 232 may provide raw output, e.g., voltages or currents, from one or more of the detectors, which may then be processed by the ML engine 210 or another technique to obtain the relevant pulse information. Similarly, other sensors may provide raw, filtered, or processed sensor information to the ML engine 210

While the example system 200 shown in FIG. 2 only includes three sensors 232-236, it should be appreciated that any number or type of sensor may be employed according to different examples.

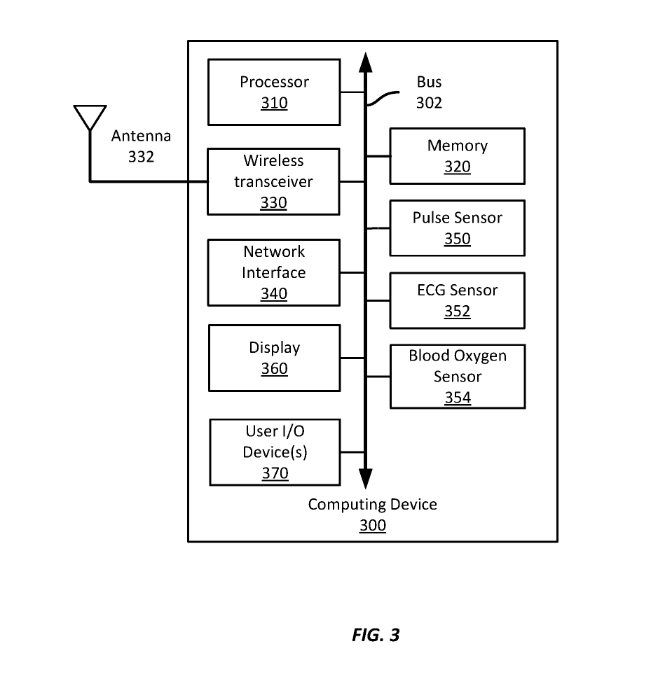

Referring now to FIG. 3, FIG. 3 shows an example computing device 300 for remote patient monitoring and event detection. The example computing device 300 includes a processor 310, memory 320, a network interface 340, a display 360, user input and output devices 370, a pulse sensor 350, an ECG sensor 352, and a blood oxygen sensor 354 in communication with each other via bus 302. In addition, the computing device 300 includes a wireless transceiver 330 and an associated antenna 332. The processor 310 is configured to execute processor-executable program code stored in the memory 320 to execute one or more methods for remote patient monitoring and event detection according to this disclosure.

In this example, the computing device 300 is an IOT hub. However, the computing device may be any computing device configured as an edge device, such as the edge device 120 shown in FIG. 1. In some examples, however, the computing device 300 may be any patient device, such as patient device 112, that can receive sensor signals and communicate with the edge device 120. In this example, the IOT hub 300 obtains sensor signals from its sensors 352-354 at a configured rate, such as once every minute. This rate may be established by a configuration setting selected by the patient, a health care provider system 140, a service platform system 150, and ERS system 160, or based on a setting received from the edge device 120.

In examples where the computing device 300 is a patient device 112, e.g., a smartwatch, sensor signals may be received by the smartwatch at a higher rate than it transmits sensor information to the edge device. Thus, in some examples, the smartwatch 300 may buffer the sensor information in memory 320 prior to transmission, and then may transmit a set of buffered sensor information at the scheduled time. In some examples, however, the smartwatch 300 may stream sensor information to the edge device 120 as sensor signals are received and new sensor information becomes available.

While the computing device 300 in this example is an IOT hub, computing devices may function as patient devices, edge devices, or as components of other systems, such as a health care provider system 140, service platform system 150, or an ERS system 160. In some such scenarios, computing devices may lack sensors, such as sensors 350-354, a display 360, or user input/output devices 370. For example, a server computing device may lack sensors 350-354, a display, user input/output devices, and the wireless transceiver 330 and antenna 332.

Examples of suitable computing devices according to this disclosure include laptop computers, desktop computers, tablets, phablets, satellite phones, cellular phones, dedicated video conferencing equipment, IOT hubs, virtual assistant devices (such as Alexa®, Home®, etc.), wearable devices (such as smart watches, earbuds, headphones, Google Glass®, etc.), etc.

In this example, the IOT hub 300 is equipped with a wireless transceiver 330 and corresponding antennas 332 configured to wirelessly communicate using any suitable wireless technology with any device, system or network that is capable of transmitting and receiving RF signals according to any of the IEEE 16.11 standards, or any of the IEEE 802.11 standards, the BT standard, near-field communications (“NFC”) standards, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IOT) network, such as a system utilizing 3G, 4G or 5G, or further implementations thereof, technology.

While the example computing device 300 shown in FIG. 3 employs wireless communication techniques, in some examples, the example computing device 300 may employ one or more wired communication techniques, such as via network interface 340, including Ethernet, token ring, plain old telephone service (“POTS”), Universal Serial Bus (“USB”), FireWire 1394, Apple® Lightning® interface, serial or parallel communication techniques (e.g., RS-232, RS-485, IEEE 1284, etc.), analog voltage or current communication lines, etc.

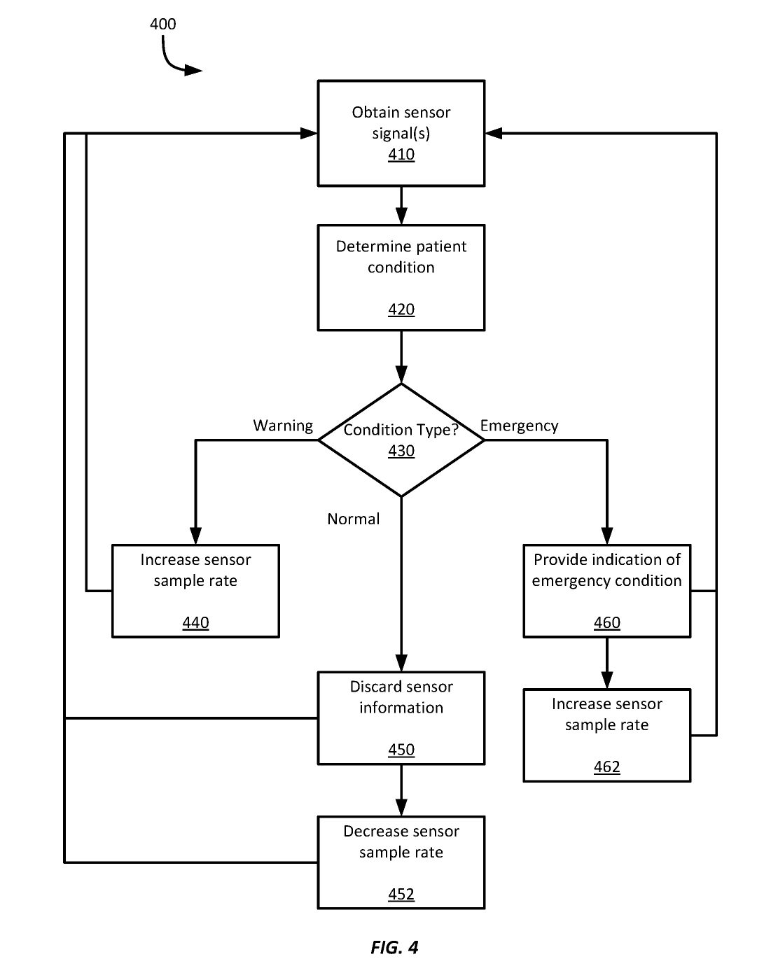

Referring now to FIG. 4, FIG. 4 shows an example method 400 for remote patient monitoring and event detection. The example method 400 of FIG. 4 will be discussed with respect to the systems 100, 200 shown in FIGS. 1 and 2 and with respect to the computing device 300 shown in FIG. 3. However, it should be understood that any suitable system according to this disclosure may be employed according to different examples.

At block 410, the edge device 120 obtains one or more sensor signals from a sensor associated with a patient, such as patient sensors 110a-n. In this example, the edge device 120 is in proximity to the patient, such as in the patient's home, vehicle, office, etc., or carried by or worn by the patient. The edge device 120 in this example wirelessly receives sensor signals using a wireless transceiver and antenna, such as the wireless transceiver 330 and antenna 332 shown in FIG. 3, using any suitable wireless communications technique. In some examples the edge device 120 may receive sensor signals using one or more wired communications techniques, such as discussed above with respect to network interface 340.

The edge device 120 may receive sensor signals directly from one or more sensors, or in some examples the edge device 120 may receive sensor information from a patient device, such as a smartphone or a smartwatch, which is in direct communication with one or more patient sensors 110a-n. The patient device 112 may receive the sensor signals, extract sensor information from the received sensor signal(s), and transmit the sensor information to the edge device 120. In some examples, however, the patient device may relay one or more sensor signals to the edge device 120.

In this example, the edge device 120 receives sensor signals at one or more sampling rates. For example, one or more of the patient sensors 110a-n may be configured to sample data at a particular rate, such as once per second. A sensor may then transmit a sensor signal to the edge device 120, or other patient device, at the sampling rate. In some examples, however, the sensor signals may be obtained by polling a sensor. For example, the edge device 120 may request a sensor reading from a patient sensor at a configured sample rate and, in response, receive a sensor signal in response, or the edge device 120 may receive sensor signals from a sensor at a rate higher than the configured sample rate and discard excess sensor signals.

Sampling rates in some examples may be established based on a determined patient condition. For example, an edge device may be configured with four sampling rates, which may be selected based on a detected patient condition. A “normal” sampling rate may be associated with sampling for a first period of time following a medical event, such as release from a hospital or in-patient clinic. Such a “normal” sampling rate may be relatively frequency, such as at a rate of once per thirty seconds. If, after a reference period of time, such as 24 hours, if a detected patient condition remains “normal,” a “reduced” or “low rate” sampling rate may be employed, which may have an infrequent sampling rate, such as once per minute or once per five minutes, or at one-half or one-third the “normal” rate, for example. However, if a “warning”-type patient condition is detected, the edge device 120 may select a relatively high sample rate, such as, for example, once per ten seconds, or twice to five times as often as a “normal” sampling rate. If an “emergency”-type patient condition is detected, the edge device 120 may select an “emergency” sampling rate, which may be once per second, at the highest rate available from a particular sensor, or a continuous stream of sensor signals.

It should be appreciated that while an edge device 120 may receive sensor signals at a particular sampling rate, one or more of the patient sensors 110a-n may obtain sensor information at a higher or lower rate than the edge device's sampling rate. For example, a pulse sensor may obtain sensor information continuously to count pulses, while providing pulse counts to the edge device 120 at the selected sampling rate. Similarly, a patient device may obtain sensor information from one or more sensors, store the received sensor information, and provide the stored sensor information to the edge device 120 at a sampling rate. Thus, in some examples, a sampling rate may relate to a rate at which the edge device 120 receives sensor signals. However, in some examples, one or more sensors may be configured to only obtain samples, or only to transmit sensor signals at a particular sampling rate.

At block 420, the edge device 120 determines a patient condition based on the one or more sensor signals using a trained ML model. In this example, the edge device 120 executes a ML engine 210 which accepts the sensor information as inputs and generates, using one or more trained ML models 212a-n, one or more patient conditions 220. Patient conditions 220 may include specific physiological anomalies, such as high or low blood pressures, high or low pulse rates, high or low blood oxygen levels or respiration rates, etc. Patient conditions may also (or instead) include health conditions, such as “heart attack,” “blood loss,” stroke,” “shock,” “allergic reaction,” etc. In some examples, the edge device 120 may provide patient history information to the ML engine 210. For example, the edge device 120 may provide information about one or more chronic conditions, past surgeries or injuries, existing injuries, etc. Such information may be employed by the ML engine 210 to further help obtain the patient condition.

In some examples, the ML engine 210 may execute multiple trained ML models 212a-n. For example, the ML engine 210 may execute an ML model that has been trained for a specific temporary condition, such as recovery following heart surgery, that may detect specific conditions associated with heart surgery, such as infections, irregular heartbeats or pulse rates, etc. In addition, the ML engine 210 may also execute an ML model that has been trained for generalized health monitoring that can detect conditions such as strokes, injuries, etc. that may occur while a patient is recovering from heart surgery, but are not generally associated with recovery from heart surgery. The ML engine 210 may further execute one or more trained ML models for chronic health conditions the patient has. Thus, the ML engine 210 may accept sensor information and provide some or all of the sensor information to one or more trained ML models 212a-n to determine one or more patient conditions.

While in this example, the ML engine 210 is executed by the edge device 120, in some examples, other devices may execute an ML engine 210, or multiple devices may execute ML engines 210. For example, a patient device 112 may execute an ML engine 210 and may also provide sensor information to the edge device 120, which may also execute an ML engine. In one such examples, the patient device may execute an ML engine 210 that has one or more trained ML models 212a-k, while the edge device 120 may execute an ML engine 210 that has one or more different trained ML models 212(k+1)−n, each of which ML engines 210 may determine one or more patient conditions. It should be appreciated that labels “k” and “n” represent arbitrary values. Thus, the range “212a-k” may include any number of ML models, while range 212(k+1)−n refers to any additional arbitrary number of ML models. In addition, one or more of the health care provider system 140, the service platform system 150, or the ERS system 160 may execute an ML engine 210 to determine a patient condition.

At block 430, the edge device 120 determines a patient condition type. For example, the edge device 120 may determine whether the patient condition indicates a normal patient condition, a warning-type patient condition, or an emergency-type patient condition. In this example, the ML engine 210 indicates the type of patient condition. For example, the ML engine 210 may indicate that the patient's blood pressure and heartbeat are within normal ranges or simply are “normal.” If the patient condition is of a normal type, the method 400 proceeds to block 450. However, a determined patient condition may be a “warning” type condition, or the ML engine 210 outputs a flag, metadata, or other indication associated with a determined patient condition to indicate that the condition is a “warning” type condition. If this occurs, the method 400 proceeds to block 440. Further, if the patient condition is of an “emergency” type condition, or the ML engine 210 outputs a flag, metadata, or other indication associated with a determined patient condition to indicate that the condition is an “emergency” type condition, the method 400 proceeds to block 460.

It should be appreciated that multiple different types of patient conditions may be determined substantially simultaneously with each other. For example, the ML engine 210 may execute a trained ML model 212a that determines multiple patient conditions 220 based on inputted sensor information. One or more of the determined patient conditions 220 may have different types than others, thus, the method 400 may proceed to multiple blocks 440-460 substantially simultaneously.

As will be discussed in more detail below, some blocks may result increased sensor sample rates or decreased sensor sample rates. If multiple blocks 440-460 are traversed substantially simultaneously, sample rates for some sensors may be increased, while others may be decreased. Further, if one sensor is to be increased based on one determined patient condition and simultaneously decreased based on another determined patient condition, the edge device 120 may resolve the conflict by increasing the sensor sample rate in some examples.

While this example has discussed the edge device performing certain operations at block 430, it should be appreciated that other devices may execute an ML engine 210, or multiple devices may execute ML engines 210. For example, a patient device 112 may execute an ML engine 210 and may also provide sensor information to the edge device 120, which may also execute an ML engine. In one such examples, the patient device may execute an ML engine 210 that has one or more trained ML models 212a-k, while the edge device 120 may execute an ML engine 210 that has one or more different trained ML models 212k-n, each of which ML engines 210 may determine one or more patient conditions. In addition, one or more of the health care provider system 140, the service platform system 150, or the ERS system 160 may execute an ML engine 210 to determine a patient condition and, in some examples, a condition type.

In some examples, block 430 may be performed multiple times during the course of a single iteration of the example method 400. For example, the ML engine 210 may execute multiple trained ML models 212a-n, each of which may determine a patient condition. Thus, aspects of block 430 may be performed for each determined patient condition. Thus, multiple of blocks 440-460 may be performed in an iteration of the example method 400.

It should be appreciated that block 430 is an optional block in this example method 400. In some examples, the method 400 may return to block 410 immediately after completing block 420 if no notification to the patient or other entity is needed, or proceed directly to block 460 if a notification is needed. However, block 430 in conjunction with blocks 440-462, discussed in detail below, may provide additional features or granular responses to determined patient conditions.

At block 440, the edge device 120 increases a sampling rate of one or more patient sensors 110a-n. In this example, the edge device 120 increases the sampling rate by polling sensors at a higher rate or by transmitting a message to one or more sensors to change a sampling rate. In some examples, however, one or more sensors may be incorporated into a patient device, such as a smartwatch, smartphone, heartrate monitor, etc. The edge device 120 may transmit a message to the patient device to indicate a new sample rate for one or more sensors. The message may identify individual sensors and provide sample rates for each identified sensor, or may provide a sample rate for all available sensors.

In some examples, to increase a sample rate of one or more sensors, the edge device 120 may first select one or more sensors for which to increase a sample rate. In this example, the edge device 120 determines which sensors provided information to the ML engine 210 that were then provided to the trained ML model 212a-n that output the patient condition that triggered the sample rate increase. For example, if sensor information from a pulse rate sensor and an ECG sensor were provided to an ML model, e.g., ML model 212b, that output a “warning”-type patient condition, the edge device 120 may select the pulse rate sensor and the ECG sensor for increased sampling rates. But the edge device 120 may not increase the sample rate of a blood oxygen sensor because sensor information from the blood oxygen sensor was not provided to ML model 212b. Thus, the edge device 120 may selectively increase sampling rates for particular sensors. In some examples, however, the edge device 120 may increase sampling rates for all available sensors.

After increasing the sensor sampling rate, the method 400 returns to block 410, where the edge device 120 receives additional sensor signals or information. It should be appreciated that the increased sensor sampling rate may also cause an increase in the rate at which the method 400 is executed. For example, the edge device may obtain a patient condition at block 420 more frequently due to the increased amount of sensor data resulting from the increased sampling rate. Thus, the edge device 120 may be able respond more quickly if the patient's condition continues to deteriorate and an emergency is detected.

It should be appreciated that the edge device 120 may not increase a sampling rate at block 440 in some examples. For example, the edge device 120 may only increase a sampling rate after a counter or a timer reaches a reference threshold, or it may only increase the sampling rate from a “normal” sampling rate to a “warning” sampling rate, such as discussed above with respect to block 410, and not further increase the sampling rate if the “warning” patient condition persists. Further, in some examples, a system may have a maximum sampling rate, which may be a configuration setting or a technical limitation, above which the sampling rate may not be increased. A maximum sampling rate may be established for different types of conditions, in some examples. For example, a sampling rate may be raised to a first maximum sampling rate if the detected patient condition is a “warning” condition; however, a higher, second maximum sampling rate may be used if the determined patient condition is an “emergency” condition.

Further, it should be appreciated that while block 440 was discussed with respect to the edge device 120, any other patient device or one or more of the health care provider system 140, service platform system 150, or ERS system 160 may request or instruct an increased sampling rate based on a determined patient condition, whether the patient condition is received from the edge device 120 or another device or system.

At block 450, the edge device 120 discards the sensor information and the method either continues to block 452 or returns to block. In this example, the edge device 120 discards the sensor data because the patient's condition is determined to be of a “normal” type and no action is needed.

In some examples, the edge device 120 may also upload some or all of the data to a cloud storage location or to the service platform system 150 or the health provider system 140, which may archive the data, use the data to train one or more ML models, or provide the data to another third party, such as a clinical research organization, etc. The edge platform 120 may then discard the data from its own memory and either return to block 410 or proceed to block 452.

It should be appreciated that while block 450 was discussed with respect to the edge device 120, any other patient device or one or more of the health care provider system 140, service platform system 150, or ERS system 160 may discard any received sensor information.

At block 452, the edge device 120 decreases a sensor sampling rate. In some scenarios where the determined patient condition is of a “normal” type, or a determined patient condition is not of an “emergency” type, sensor sampling rates may be reduced to reduce power consumption of the patient sensors 110a-n themselves, one or more patient devices, or the edge device 120. As discussed above, the edge device 120 may be configured with one or more preconfigured sampling rates associated with detected patient conditions. Thus, to reduce a sampling rate in one example, the edge device 120 may select a preconfigured sampling rate that has a lower rate than the then-current sampling rate. However, in some examples, the edge device 120 may reduce a sampling rate by a predetermined amount, such as by a percentage of the then-current sampling rate or a fixed amount, e.g., the rate may be reduced by 1 sample per second or 10 samples per minute. For example, if a sampling rate is 5 samples per second, the rate may be reduced to 6 samples per second for a 1 sample-per-second reduction.

It should be appreciated that in some examples, the edge device 120 may not reduce the sampling rate at block 452. For example, the edge device 120 may maintain a counter associated with a “normal” condition and only reduce the sampling rate when the counter reaches a reference threshold. In some examples, the edge device 120 may have a minimum sampling rate that, when reached, prevents further reductions in sampling rates at block 452.

Further, it should be appreciated that while block 452 was discussed with respect to the edge device 120, any other patient device or one or more of the health care provider system 140, service platform system 150, or ERS system 160 may request or instruct an decreased sampling rate based on a determined patient condition, whether the patient condition is received from the edge device 120 or another device or system.

At block 460, the edge device 120 provides an indication of the emergency patient condition. In this example, the edge device 120 transmits a message to one or more of the health care provider system 140, the service platform system 150, or the ERS system 160. The message includes an identification of the determined patient condition and may include sensor information, patient information, location information, etc. Sensor information may include information from one or more received sensors, such as pulse rate, respiration rate, ECG information, blood oxygen levels, etc. Patient information may include a name, patient ID number, social security number, one or more health records, information about a chronic or temporary medical condition, etc. Location information may include geographic location, such as latitude and longitude; an address, a business name, etc. The message may include other types of information in some examples, such as a timestamp indicating when the emergency condition was determined, information relating to any warning patient conditions determined preceding or concurrently with the emergency condition, etc.

In some examples, the edge device 120 may provide a notification to the patient, such as by playing a sound, displaying a warning image or message on a display screen of the edge device 120, transmitting a message to a patient device to cause the patient device to output a notification (e.g., a sound, a graphical or text message, a vibration, etc.). Further, the edge device 120 may provide a notification to one or more of emergency contacts, such as an immediate family member (e.g., a spouse, parent, child, sibling, etc.), a roommate, a doctor, a nurse, etc.

In some examples, the edge device 120 may provide a stream of sampled sensor information to one or more of the health care provider system 140, the service platform system 150, or the ERS system 160. By providing a stream of sampled sensor information, the edge device 120 may be able to provide real-time or near-real-time patient status to one or more third parties. Such information may enable the third parties to monitor patient status, prepare for the patient's arrival, or dispatch appropriate emergency services.

In addition to providing the notification, the edge device 120 may transmit information, such as sensor information, to one or more of the health care provider system 140, the service provider system 150, or an ERS system 160. When providing such information, in some examples, the edge device 120 may tag the data with a priority tag or otherwise tag one or more data packets associated with such information as being of increased or high priority. Such a designation may enable a remote system 140-160 to prioritize reception of such information or priority processing of such information.

In some example, the edge device 120 may receive from one or more of the remote systems 140-160 requests for information or to establish voice communications in response to the notification. For example, one or more of the remote systems may request particular sensor information, real-time streams of sensor information, or a particular sampling rate. A remote system 140-160 may also request to communicate with the patient, such as via voice or video communications. In one example, the edge device 120 may receive a voice communications request, e.g., a cellular or POTS voice call, from the health care provider system 140 or the ERS system 160. The edge device 120 may either provide a notification to the patient, such as by ringing, or it may autonomously accept the request and initiate the voice communications, which may enable voice communications with a disabled or partially incapacitated patient. Similarly, video communications be established in a similar manner using available equipment, such as a smart TV that is equipped with a video camera. Video communications may enable the remote system, e.g., an ERS system 160, to view the scene to gather additional information about the patient's emergency condition.

It should be appreciated that while block 460 was discussed with respect to the edge device 120, any other patient device or one or more of the health care provider system 140, service platform system 150, or ERS system 160 may provide an indication of an emergency condition generally as discussed above.

At block 462, the edge device 120 increases a sampling rate of one or more patient sensors 110a-n. As generally discussed above with respect to blocks 440 and 452, the edge device 120 change a sampling rate based on one or more preconfigured sampling rates or may change a sampling rate based on a percentage of a then-current sampling rate. In some examples, as discussed above with respect to block 410, the edge device 120 may increase a sampling rate to a continuously sampling rate or a “fast as possible” sample rate. Further, in some examples, a system may have a maximum sampling rate, which may be a configuration setting or a technical limitation, above which the sampling rate may not be increased. And as discussed above, a maximum sampling rate may be established for different types of conditions, in some examples. For example, a sampling rate may be raised to a first maximum sampling rate if the detected patient condition is a “warning” condition; however, a higher, second maximum sampling rate may be used if the determined patient condition is an “emergency” condition.

It should be appreciated that while block 462 was discussed with respect to the edge device 120, any other patient device or one or more of the health care provider system 140, service platform system 150, or ERS system 160 may request or instruct an increased sampling rate based on a determined patient condition.

It should be appreciated that example methods according to this disclosure may include different numbers of blocks than depicted in FIG. 4. For example, a method according to this disclosure may not include one or more of blocks 440, 450, 452, and 462. Instead, the edge device 120 (or other device(s) or system(s) according to this disclosure) may reach block 430, and if no emergency condition is determined, the method may return to block 410, while if an emergency condition is detected, the method may proceed to block 460 and then return to block 410.

While the methods and systems herein are described in terms of software executing on various machines, the methods and systems may also be implemented as specifically-configured hardware, such as field-programmable gate array (FPGA) specifically to execute the various methods. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. A method comprising:
obtaining, by a computing device via wireless communication, one or more sensor signals from a sensor associated with a patient;
determining a patient condition based on the one or more sensor signals using a trained machine-learning (“ML”) model; and
responsive to detecting an emergency condition based on the patient condition, providing an indication of the emergency condition.

2. The method of claim 1, wherein providing the indication of the emergency condition comprises transmitting a message to (i) a health care provider, (ii) a service provider platform, (iii) the patient, (iv) a member of the patient's family, (v) an emergency services provider, or (vi) any combination of (i) to (v), the message comprising the indication of the emergency condition.

3. The method of claim 2, wherein the message further comprises (a) a physical address for the patient, (b) global navigation satellite system (“GNSS”) coordinates for the patient, (c) physician information, (d) health care information, or (e) any combination of (a) to (d).

4. The method of claim 1, wherein the computing device comprises a smartphone or an internet-of-things (“IOT”) hub.

5. The method of claim 1, wherein obtaining the patient condition comprises, executing, by the computing device, the trained ML model using the one or more sensor signals.

6. The method of claim 1, further comprising updating the trained ML model based on the one or more sensor signals.

7. The method of claim 6, wherein the updating the trained ML model is performed by the computing device.

8. The method of claim 1, further comprising:
receiving the trained ML model from a remote computing device;
providing the one or more sensor signals to the remote computing device; and
receiving an updated trained ML model from the remote computing device, the updated trained ML model trained based on the one or more sensor signals.

9. The method of claim 1, further comprising:
receiving, by the computing device, a voice communication request from a remote device; and
establishing a voice communication with the remote device.

10. The method of claim 1, further comprising:
detecting a non-emergency condition based on the patient condition;
discarding the one or more sensor signals; and
reducing a time interval between receiving sensor signals.

11. The method of claim 1, further comprising:
detecting a non-emergency condition based on the patient condition, the non-emergency condition comprising a warning condition; and
increasing a time interval between receiving sensor signals.

12. The method of claim 1, further comprising:
detecting an emergency condition based on the patient condition; and
providing, using a high priority indicator, sensor information to a remote computing system, the sensor information based on the obtained sensor signals associated with the emergency condition.

13. A computing device comprising:
a wireless transceiver;
a non-transitory computer-readable medium; and
a processor in communication with the wireless transceiver and the non-transitory computer-readable medium, the processor configured to:
obtain, using the wireless transceiver, one or more sensor signals from a sensor associated with a patient;
determine a patient condition based on the one or more sensor signals based on a trained machine learning (“ML”) model;
detect an emergency condition based on the patient condition; and
provide an indication of the emergency condition.

14. The computing device of claim 13, wherein the processor is further configured to transmit a message to (i) a health care provider, (ii) a service provider platform, (iii) the patient, (iv) a member of the patient's family, (v) an emergency services provider, or (vi) any combination of (i) to (v), the message comprising the indication of the emergency condition.

15. The computing device of claim 14, wherein the message further comprises (a) a physical address for the patient, (b) global navigation satellite system (“GNSS”) coordinates for the patient, (c) physician information, (d) health care information, or (e) any combination of (a) to (d).

16. The computing device of claim 13, wherein the processor is further configured to execute the trained ML model using the one or more sensor signals.

17. The computing device of claim 13, wherein the processor is further configured to o:
receive the trained ML model from a remote computing device;
provide the one or more sensor signals to the remote computing device; and
receive an updated trained ML model from the remote computing device, the updated trained ML model trained based on the one or more sensor signals.

18. The computing device of claim 13, wherein the processor is further configured to:
detect a non-emergency condition based on the patient condition;
discard the one or more sensor signals; and
reduce a time interval between receiving sensor signals.

19. The computing device of claim 13, wherein the processor is further configured to:
detect a non-emergency condition based on the patient condition, the non-emergency condition comprising a warning condition; and
increase a time interval between receiving sensor signals.

20. A non-transitory computer-readable medium comprising processor-executable instructions configured to cause a processor of a computing device to:
obtain, via wireless communication, one or more sensor signals from a sensor associated with a patient;
determine a patient condition based on the one or more sensor signals based on a trained machine-learning (“ML”) model;
detect an emergency condition based on the patient condition; and
provide an indication of the emergency condition.

21. The non-transitory computer-readable medium of claim 20, wherein the processor-executable instructions are further configured to cause the processor to transmit a message to (i) a health care provider, (ii) a service provider platform, (iii) the patient, (iv) a member of the patient's family, (v) an emergency services provider, or (vi) any combination of (i) to (v), the message comprising the indication of the emergency condition.

22. The non-transitory computer-readable medium of claim 21, wherein the message further comprises (a) a physical address for the patient, (b) global navigation satellite system (“GNSS”) coordinates for the patient, (c) physician information, (d) health care information, or (e) any combination of (a) to (d).

23. The non-transitory computer-readable medium of claim 20, wherein the processor-executable instructions are further configured to cause the processor to execute the trained ML model using the one or more sensor signals.

24. The non-transitory computer-readable medium of claim 20, wherein the processor-executable instructions are further configured to cause the processor to update the trained ML model based on the one or more sensor signals.

25. The non-transitory computer-readable medium of claim 20, wherein the processor-executable instructions are further configured to cause the processor to:
receive the trained ML model from a remote computing device;
provide the one or more sensor signals to the remote computing device; and
receive an updated trained ML model from the remote computing device, the updated trained ML model trained based on the one or more sensor signals.

26. The non-transitory computer-readable medium of claim 20, wherein the processor-executable instructions are further configured to cause the processor to:
detect a non-emergency condition based on the patient condition;
discard the one or more sensor signals; and
reduce a time interval between receiving sensor signals.

27. The non-transitory computer-readable medium of claim 20, further comprising:
detecting a non-emergency condition based on the patient condition, the non-emergency condition comprising a warning condition; and
increasing a time interval between receiving sensor signals.

28. An apparatus comprising:
means for obtaining one or more sensor signals from a sensor associated with a patient;
means for determining a patient condition based on the one or more sensor signals based on a trained machine-learning (“ML”) model;
means for detecting an emergency condition based on the patient condition; and
means for providing an indication of the emergency condition.

29. The apparatus of claim 28, means for executing the trained ML model using the one or more sensor signals.

30. The apparatus of claim 28, further comprising:
means for receiving the trained ML model from a remote computing device;
means for providing the one or more sensor signals to the remote computing device; and
means for receiving an updated trained ML model from the remote computing device, the updated trained ML model trained based on the one or more sensor signals.
